(19) United States
(12) Patent Application Publication
(10) Pub. No.: US 2005/0179739 A1
(43) Pub. Date: Aug. 18, 2005

(54) Methods and apparatus for thermal fluid jet drop volume control using variable length pre-pulses

(75) Inventors: Eduardo M. Freire, Kennett Square, PA (US); John H. Slowik, Penfield, NY (US); Andrew S. Yeh, Portland, OR (US); Roger G. Markham, Webster, NY (US); William P. Rhodes, Newark, DE (US)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/778,577

(22) Filed: Feb. 17, 2004

(51) Int. Cl. B41J 29/38

(52) U.S. Cl. 347/61

(57) ABSTRACT

A method and apparatus are providing for controlling the drop volume of a thermal fluid jet fluid ejecting head. The fluid ejecting head has a plurality of drop ejectors, each of the plurality of drop ejectors has a heating element activated in response to input signals to eject an ink droplet from the fluid ejecting head. The method includes the steps of applying a plurality of print signals to the fluid ejecting head, the plurality of print signals corresponding to an image for the fluid jet assembly to create, applying at least two pre-pulse signals of different duration to the fluid ejecting head, and using the at least two pre-pulse signals and the plurality of print signals to activate the heating elements so that a desired drop volume results.

### BACKGROUND OF THE INVENTION

1. Field of Invention

This invention relates to methods and apparatus used in thermal fluid jet printers.

2. Description of Related Art

A thermal fluid jet fluid ejecting head selectively ejects droplets of fluid from a plurality of drop emitters to create a desired image on an image receiving member, such as a sheet of paper. The fluid ejecting head typically comprises an array of the drop emitters that convey fluid to the image receiving member. In a carriage-type fluid jet fluid ejecting head, the fluid ejecting head moves back and forth relative to the image receiving member to print the image in swaths.

Alternatively, the array extends across the entire width of the image receiving member to form a full-width fluid ejecting head. Full-width fluid ejecting heads remain stationary as the image receiving member moves in a direction substantially perpendicular to the array of drop emitters.

A thermal fluid jet fluid ejecting head typically comprises a plurality of fluid passageways, such as capillary channels. Each channel has a drop emitter and is connected to a fluid supply manifold. Fluid from the manifold is retained within each channel. Then, in response to an appropriate signal applied to a resistive heating element in each channel, the fluid in a portion of the channel adjacent to the heating element is rapidly heated. Rapidly heating and vaporizing some of the fluid in the channel creates a bubble that causes a quantity of fluid, such as an ink droplet or a main ink droplet and smaller satellite drops, to be ejected from the emitter to the image receiving member. U.S. Pat. No. 4,774,530 to Hawkins, the disclosure of which is incorporated herein by reference in its entirety, shows a general configuration of a typical fluid jet fluid ejecting head.

U.S. Pat. No. 4,791,435 to Smith et al., the disclosure of which is incorporated herein by reference in its entirety, discloses an fluid jet system where a constant temperature of the fluid ejecting head is maintained by using the heating elements of the fluid ejecting head not only for ejecting ink but to maintain the temperature close to a predetermined value as well. The fluid ejecting head temperature is compared to thermal models of the fluid ejecting head to provide information for controlling the fluid ejecting head temperature. At low temperature, low energy pulses are sent to each channel, or nozzle, below the voltage threshold that would cause a drop of fluid to be ejected. Alternatively, the fluid ejecting head is warmed by firing some droplets of ink into an external chamber or “spittoon,” rather than onto the surface of the image receiving member.

European Patent Application 0 496 525 A1, the disclosure of which is incorporated herein by reference in its entirety, discloses fluid jet recording method and apparatus in which ink is ejected by thermal energy produced by a heat generating element of a recording head. In the EP 525 application, driving circuits apply plural driving pulses to the heat generating element for every ink droplet ejected. The plural driving pulses include a first driving pulse used to increase a temperature of the ink adjacent the heater without creating a bubble, and a second driving pulse subsequent to the first driving pulse to eject the ink. Additionally, a width of the first driving pulse is adjustable to change an amount of ejected ink.

European Patent Application 0 505 154 A2, the disclosure of which is incorporated herein by reference in its entirety, discloses thermal fluid jet recording method and apparatus which control an ink ejection quantity by changing driving pulses supplied to the recording head based on a variation in the temperature of the recording head. A preheat pulse is applied to the ink to control the ink temperature and is set to a value which does not cause an ink bubble to form. After a predetermined time interval, a main heat pulse is applied which forms an ink bubble to eject one or more droplets, such as a main droplet and satellite droplets, of ink from the ink channel.

### SUMMARY OF THE DISCLOSURE

This invention provides methods and apparatus for using a fluid ejecting head having a plurality of drop ejectors.

This invention separably provides systems and methods for varying the duration of pre-pulses.

This invention separably provides systems and methods for varying the duration of pre-pulses to sequentially pre-warm and fire fluid ejectors.

In various exemplary embodiments, a first set of pre-pulses are longer in duration than a second, subsequent set of pre-pulses, thereby maximizing drop volume for a given energy input.

In various exemplary embodiments, using a pulse train having multiple pre-pulses, longer pre-pulses are used initially, followed by smaller pre-pulses as the temperature of the ink layer rises. The longer pre-pulses initially result in a deeper energy penetration into the ink and consequently a larger, faster drop. This results in a more consistently controlled temperature of the ink/heater boundary layer, and reduces the possibility of early bubble nucleation.

In various exemplary embodiments, each ejector has a heating element actuatable in response to input or data signals to emit a quantity of fluid from the fluid ejecting head toward an image receiving member. Pulse trains comprising of a series of variable duration pre-pulses are used as the input signals. The pulse train can be determined based on, for example, the temperature of the fluid ejecting head.

In various exemplary embodiments, the sequential and cumulative firings of the pre-pulses and final or drop-forming pulses in the selected channels throughout the fluid ejecting head are performed in a manner to achieve the fastest possible drop velocities.

In various exemplary embodiments, the sequential and cumulative firings of the pre-pulses and final or drop-forming pulses in the selected channels throughout the fluid ejecting head are performed by loading image data from the printer controller into a print data array. The heating elements are then fired in a sequence controlled by pulse trains originating in a fluid ejecting head controller. The pulse trains are clocked to sequence the firing of the heating elements in a manner that results in the maximum possible drop volume range.

In various exemplary embodiments of this invention, using wave forms with variable length pre-pulses allows drop mass to be stable over substantial temperature and pulse train ranges. The fluid ejecting head circuit design reads these arbitrary wave forms.

Other objects, advantages and features of the invention will become apparent from the following detailed description taken in conjunction with the attached drawings, which disclose exemplary embodiments of the invention.

### BRIEF DESCRIPTION OF THE DRAWINGS

The invention will be described with reference to the following drawings in which like reference numerals refer to like elements and wherein:

FIG. 1 is a schematic view of a fluid jet printer;

FIG. 2 is a cross-sectional view of a single ejector channel for a thermal fluid jet fluid ejecting head;

FIG. 3 is a conventional timing diagram showing how multiple fixed-length pre-pulses are applied in a printing device to banks of emitters;

FIG. 4 is the temperature history for multiple pre-pulses in a conventionally driven thermal fluid jet fluid ejecting head;

FIG. 5 shows an optimal heater temperature history vs. time graph for multiple pre-pulses in a thermal fluid jet fluid ejecting head according to the present invention;

FIG. 6 shows an advantageous temperature history vs. time graph for multiple pre-pulses in a thermal fluid jet fluid ejecting head according to the present invention;

FIG. 7 shows one exemplary embodiment of a variable length pre-pulse train according to the present invention;

FIG. 8 is a drop velocity vs. time graph used to determine an optimum main firing pulse length;

FIG. 9 is a listing of examples of enable train embodiments used to determined the optimum waveform for a fluid ejecting head; and

FIG. 10 is a contour plot of drop velocity generated from a number of pre-pulses (horizontal axis) and the types of pre-pulse (vertical axis) shown in FIG. 9.

### DETAILED DESCRIPTION OF PREFERRED EMBODIMENTS

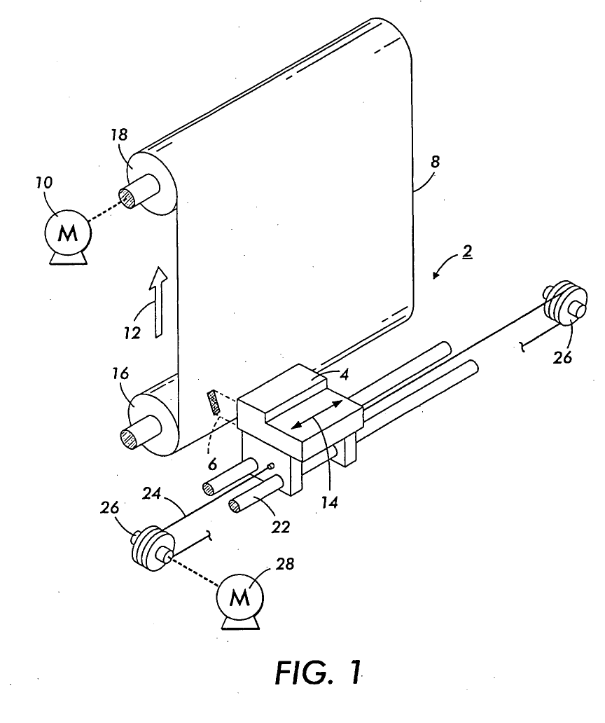

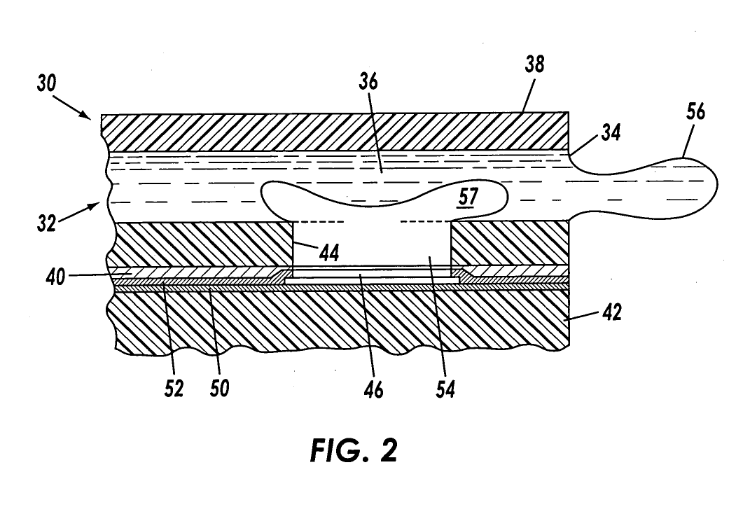

For simplicity and clarification, the operating principles and design factors of various exemplary embodiments of the systems and methods according to this invention are explained with reference to one exemplary embodiment of a carriage-type fluid jet printer 2, as shown in FIG. 1, and one exemplary embodiment of a fluid ejecting head 30, as shown in FIG. 2.

The basic explanation of the operation of the fluid jet printer 2 and the fluid ejecting head 30 is applicable for the understanding and design of any fluid ejection system that incorporates this invention. Although the systems and method of this invention are described in conjunction with the fluid jet printer 2 and the fluid ejecting head 30, the systems and methods according to this invention can be used with any other known or later-developed fluid jet ejection system.

FIG. 1 shows a carriage-type thermal fluid jet printing device 2. A linear array of droplet producing channels is housed in a fluid ejecting head 4 mounted on two parallel guide rails 22. Alternatively, the linear array of droplet producing channels extend across the entire width of the receiving medium 8. A number of ink or medicament droplets 6 are propelled towards a receiving medium 8, such as a sheet of paper, that is stepped by a motor 10 a pre-selected distance in a process direction, indicated by the arrow 12, each time the fluid ejecting head 4 traverses across the receiving medium 8 along the scan axis indicated by arrow 14. The receiving medium 8 can be stored on a supply roll 16 and stepped onto a take up roll 18 by the motor 10 or other means well known to those of skill in the art.

The fluid ejecting head 4 is fixedly mounted on the support base 20, which reciprocally moves along the two parallel guide rails 22. According to various exemplary embodiments, support base 20 alternately moves reciprocally along a single shaft, with a slot to prevent rotation (not shown). The fluid ejecting head 4 is reciprocally moved by a cable 24 and a pair of pulleys 26, one of which is powered by a reversible motor 28. Alternatively, according to various other exemplary embodiments, fluid ejecting head 4 is moved by a motor driven belt (not shown). The fluid ejecting head 4 is generally moved across the receiving medium 8 perpendicularly to the direction that the receiving medium 8 is moved by the motor 10. Of course, any other known or later-developed structure usable to reciprocally move the carriage assembly 5 can be used in the thermal fluid jet printing device 2.

FIG. 2 shows one exemplary embodiment of an ink droplet emitter or ejector 30 of one embodiment of a typical fluid jet fluid ejecting head 4. A plurality of such emitters 30 are found in a typical thermal fluid jet fluid ejecting head 4. While FIG. 2 shows a side-shooter emitter, other emitters, such as roof-shooter emitters, may similarly be used with the systems, the methods and the architectures according to this invention. In an exemplary embodiment, the emitters 30 are sized and arranged in linear arrays of 300 or more per inch. Other dimensions can be used in other exemplary embodiments, as known to those skilled in the art.

A silicon member having a plurality of ink channels is known as a “die module” or “chip”. Each die module can comprise hundreds, thousands, or more of the emitters 30, spaced 300 or more to the inch. An exemplary full-width thermal fluid jet fluid ejecting head has one or more die modules forming a full-width array extending across the full width of the receiving medium on which the image is to be printed. In fluid ejecting heads with multiple die modules, each die module includes its own ink supply manifold, or multiple die modules share a common ink supply manifold.

Each emitter 30 includes a capillary channel 32 terminating in an orifice or nozzle 34. The capillary channel 32 holds a quantity of fluid 36, such as ink, but not limited to ink, maintained within the capillary channel 32 until such time as a droplet of fluid is to be emitted. Each capillary channel 32 is connected to a supply of fluid from a fluid supply manifold (not shown). An upper substrate 38 is located adjacent to a thick film layer 44, which in turn is adjacent to a lower substrate 42.

Addressing electrodes 52 are sandwiched between the thick-film layer 44 and the lower substrate 42. The addressing electrodes 52 control and carry electrical current to one or more electrical heating elements 46 located within openings 54 in the thick film layer 44. Each of the ejectors 30 in the fluid ejecting head has its own heating element 46 and individual addressing electrode 52. In various exemplary embodiments, the addressing electrode 52 is protected by a passivation layer 40 and an insulating layer 50. Each addressing electrode 52 and associated heating element 46 is selectively controlled by control circuitry, as will be explained in detail below, to form and grow vapor bubbles in the fluid 36 due to heating the fluid 36 in contact with the heater element 46, with droplets 56 of the ink being subsequently ejected from the fluid ejecting head 4. Other known or later developed embodiments of the fluid ejecting head are also within the scope of this invention.

In operation, the thermal fluid jet fluid ejecting head applies a plurality of pulses to the heating element for each fluid droplet to be ejected. Zero or more variable length precursor pulses, i.e., warming pulses or pre-pulses, are applied by the heating element to warm the fluid adjacent to the heating element. Subsequently, a print pulse, i.e., a drive pulse, a firing pulse or a main pulse, is applied to the heating element. The print pulse causes the fluid droplet to be ejected. The pre-pulses are used to raise the temperature of the fluid adjacent to the heating element and additionally are used to control the volume of the fluid droplet. The pre-pulses do not contain enough energy to cause the fluid droplet to be emitted, and do not need to be applied at all if the fluid is initially at a sufficiently high temperature.

More particularly, in the thermal fluid jet printing process according to this invention, when a signal is applied from a power source to the addressing electrode using the control circuitry, the heating element is energized. This very rapidly raises the temperature of the heating element, as well as the temperature of the fluid that is in physical contact with the heater element. The ink increases in temperature until the ink is above its boiling point. As temperature of the ink continues to increase, the fluid in the neighborhood of the heating element may become superheated, i.e., heated beyond the normal boiling temperature of the fluid, if the heating element is energized with sufficient magnitude and/or duration. At this point, the fluid immediately adjacent to the heating element will vaporize, creating a bubble 57 (item 57 in FIG. 2) of vaporized fluid.

The vapor bubble begins to expand under the influence of the high initial vapor pressure, which can be, in various exemplary embodiments, several tens or hundreds of atmospheres, and continues to expand due to inertial effects.

As the size of the vapor bubble grows, the pressure in the vapor bubble decreases, due in part to the increase in the volume of the vapor bubble. However, the pressure in the vapor bubble decreases as well due to cooling caused by the fluid lying at the initially expanding interface with the vapor bubble. This cooling occurs due to the fluid evaporating at the bubble-fluid interface, as well as to heat conducting from the vapor bubble into the surrounding fluid.

Following initial growth of the vapor bubble, the heating element loses contact with the fluid. Accordingly, subsequent growth of the vapor bubble is essentially unaffected by the temperature of the heating element. Thus, the eventual size of the vapor bubble, and thus the size of the droplet of the fluid ejected from the nozzle, depends on the energy stored in the layer of superheated fluid that was in contact with the heating element when the vapor bubble nucleated. With higher fluid ejecting head and ink temperatures, there is more energy stored in the superheated fluid next to the heater element when the ink temperature reaches the nucleation value.

In addition, the viscosity of the fluid depends on the temperature of the fluid. In particular, higher fluid temperatures lead to lower viscosity, and similarly reduced resistance to flow. Thus, high temperatures cause more energy to be stored in the superheated layer in the fluid, and cause lower resistance to the impulsive flow involved in ejecting the fluid droplets. As a result, drop volumes increase with fluid ejecting head temperature.

Only a small fraction of the energy dissipated in the heater element is utilized in nucleating the vapor bubble and producing the fluid droplet. The remainder of the heat flows into the die and the rest of the fluid ejecting head or print head, raising their temperature. Thus, continued use of the thermal inkjet fluid ejecting head causes the temperature of the thermal inkjet fluid ejecting head to increase. Unless some device, structure or apparatus is provided to prevent drop masses from changing, drop masses will increase with continued use of the thermal inkjet fluid ejecting head, thus degrading print quality. In addition, thermal inkjet fluid ejecting heads are used within a range of ambient temperatures. Variations in the ambient temperature exacerbate the variations in droplet masses due to the self-heating effect described above.

Simply changing pulse width or voltage in response to changes in fluid ejecting head temperature is a costly method of maintaining a constant drop volume as the temperature of the thermal inkjet fluid ejecting head changes. This occurs due to the de-coupling of the heater element from the fluid by the vapor bubble once the vapor bubble forms and due to the existence of a minimal or threshold voltage below which no droplet is produced.

The energy input to the heating element can be varied to provide different energy amounts stored in the layer of superheated fluid at the time of vapor bubble nucleation, by breaking the heating pulses into two or more segments. Following this technique, energy is supplied to the heater element and the fluid via one or more pre-pulses that locally heat the fluid. In various exemplary embodiments, the fluid is heated to temperatures above the normal boiling point of the fluid, to provide some superheat in the fluid, but not to the temperature required for a vapor bubble to form and grow. With the fluid next to the heater element thus pre-heated, a relatively short off time allows the heat to diffuse deeper into the fluid, while the temperature of the fluid next to the heater decreases. A subsequent main or firing pulse, possibly having a longer duration, is then provided to the heater element to re-heat the fluid next to the heater element to the nucleation temperature, where a vapor bubble forms, causing a droplet of the fluid to be ejected.

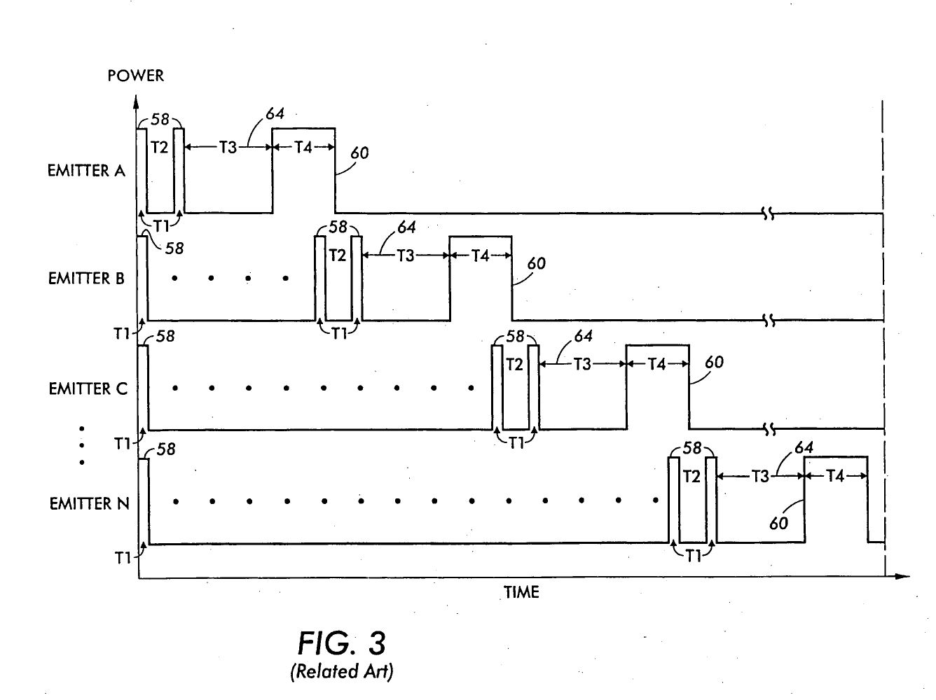

FIG. 3 is a timing diagram showing how conventional pre-pulse and firing signals are applied to the emitters or banks of the emitters, in a thermal inkjet fluid ejection head. A non-nucleating pre-pulse 58, having a duration T1, is followed by a time interval T2, which in turn is followed by one or more pre-pulses pulses 58 also having a duration T1, are applied to an emitter, or an emitter bank, A, to warm the fluid and/or to control a size of the fluid droplet to be ejected. This is followed by a relaxation time interval 64 having a duration T3. Then, a print pulse 60 having a duration T4 is applied to a specific emitter or the emitter bank A. Concurrently or subsequently, a precursor pulse 58 having a duration T1, followed by a time interval T2, which in turn is followed by one or more precursor pulses 58 each also having a duration T1, are followed by a second relaxation time interval 64 and a print pulse 60 are applied to an emitter, or an emitter bank, B. This process continues across the fluid ejecting head in serial fashion until all the emitters, or all of the emitter banks, required to eject drops of fluid have been addressed.

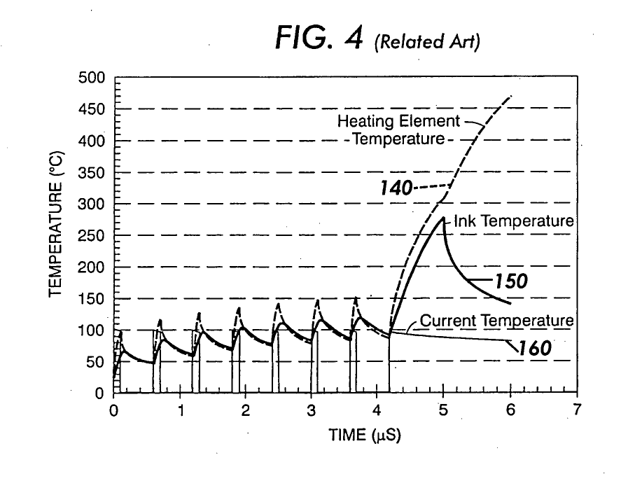

FIG. 4 shows a conventional temperature vs. time evolution graph for the fluid next to the heater element of a fluid ejecting head driven by the pre-pulse waveform shown in FIG. 3. FIG. 4 also shows corresponding plots of the heating element temperature 140, the fluid or ink temperature 150, and the current 160 delivered to the fluid 36. As shown in FIG. 4 the heating element temperature 140 peaks at ever increasing levels at the end of each pre-pulse. Because the heating element temperature 140 must always remain below the early nucleation temperature until an ejection of fluid is desired, it should be appreciated that the most critical pre-pulses are the pre-pulses toward the end of the pre-pulse train.

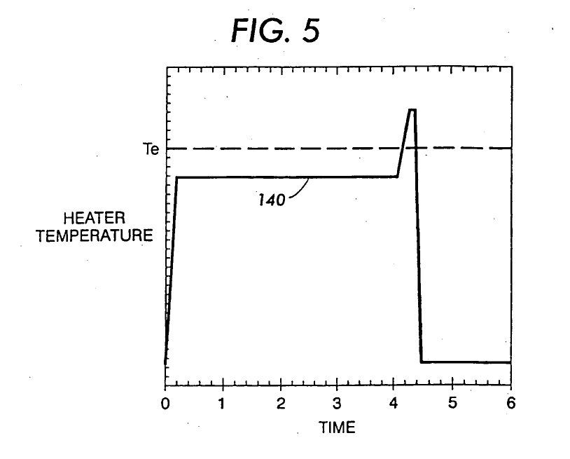

FIG. 5 graphically illustrates an optimal heater element temperature history versus time for multiple pre-pulses in a thermal fluid jet fluid ejecting head. Optimally, a pre-pulse train is tailored so that the heater element temperature 140 rises very quickly to just below Tₑ, as shown between time units 0 and 0.2, and remains constant at a temperature just below Tₑ until a main firing pulse is applied at time unit 4 which raises the heater element temperature 140 to above nucleation temperature Tₑ thereby ejecting the drop of fluid onto receiving medium 8. Thus, an optimized waveform would increase the temperature of a heating surface in relatively short amount of time, maintain constant temperature at just below the nucleation temperature Tₑ, and then increase the heater element temperature 140 to a nucleation temperature. The optimal method provides a large but non-nucleating amount of heat early so it has time to propagate deeper into the ink. This maximizes the volume of superheated fluid and keeps the temperature just below the early nucleation cap, which consequently maximizes the energy of the superheated fluid layer and the size of the subsequent vapor bubble.

In order to create such an optimum waveform, various elements may be considered. In various exemplary embodiments, these elements include, for example, the geometry of the fluid ejecting head,—the amount of fluid to be ejected depending on a print mode, the geometry of the channel, the geometry of the heating element, the properties of the fluid, and the like. The geometry of the heating element may include, for example, the type of the heating element, the area of the heating element, the shape of the heating element, and the layer structure of the heating element. One or more of the above elements may be utilized to determine which pre-pulses to use.

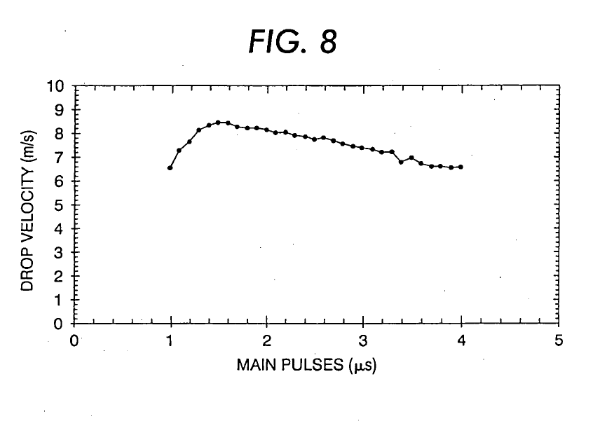

Furthermore, to obtain the optimum waveform, the following factors may also be considered: desired velocity of a drop, desired volume of drop, pre-pulse modeling, and actual collected data generated using empirical tests, as is described later with reference to FIGS. 8-10.

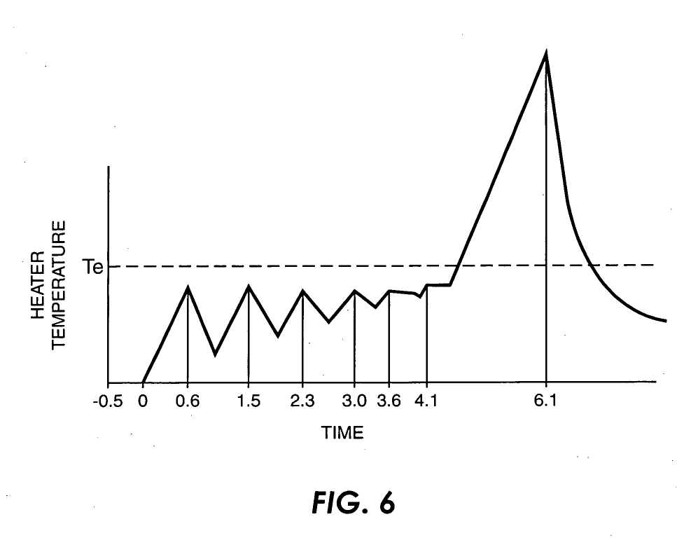

FIG. 6 shows a graphical plot of an advantageous heater temperature history versus time for multiple pre-pulses in a thermal fluid jet fluid ejecting head. FIG. 6 graphically shows a heater temperature history with constant time intervals between pre-pulses, constant pre-pulse heating slopes, and successively smaller cooling slopes between the pre-pulses. Successively smaller cooling slopes between the pre-pulses means that each new pre-pulse starts from a higher temperature than any previous pre-pulse, which thereby produces shorter pre-pulses to avoid exceeding the nucleation temperature Tₑ until it is time to fire a main firing pulse.

This heater temperature characteristic or behavior is achieved by using an initial pulse, for example, a pre-pulse, which facilitates the rising part of the temperature from time 0 until time 0.5. When the initial pulse is removed at time 0.5, the heating element starts to cool, and then the heating element is re-activated with a second pre-pulse at time 1, which is typically going to be a shorter pre-pulse than the initial pre-pulse since the heating element is at a higher temperature when the second pre-pulse is activated. This second pre-pulse heats up the heating element toward the critical nucleation temperature Tₑ. The second pre-pulse is then deactivated at time 1.5. Next, the heating element is re-activated with a third pre-pulse at time 1.8, which heats up the heating element again toward the critical nucleation temperature Tₑ. The third pre-pulse is then deactivated at time 2.3. The heating element again starts to cool, and a fourth, fifth, etc., pre-pulses are applied similarly until it is time to shoot the main firing pulse at time 4.5. Then, at time 4.5, the temperature of the heating element is spiked so that the nucleation temperature Tₑ is exceeded, thereby nucleating a vapor bubble, which produces the fluid droplet.

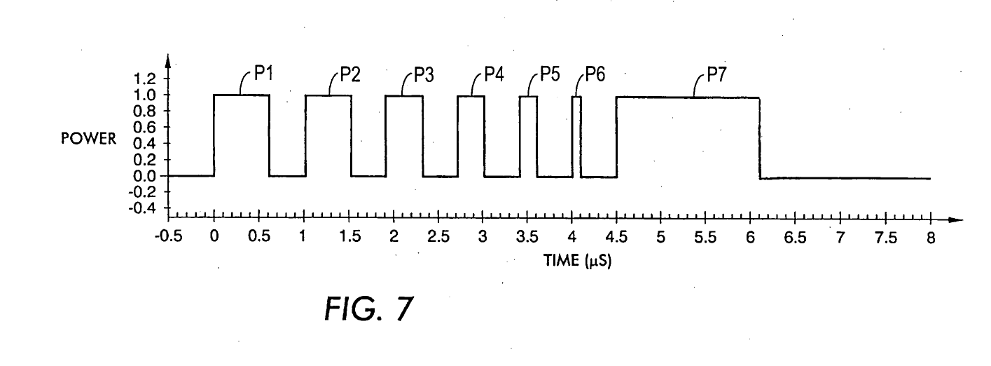

FIG. 7 shows one exemplary embodiment of a variable length pre-pulse train according to the present invention. The purpose of the pre-pulses P1-P7, e.g., non-nucleating pulses, is to pre-heat the fluid layer next to the heater surface of the heating element prior to applying the main pulse e.g., nucleating pulse to achieve a thicker super-heated fluid layer. A thicker super-heated layer results in a larger vapor bubble, which in turn produces a faster and larger drop.

One of the phenomena that typically needs to be considered when designing a pulse train to drive a thermal fluid jet heater is interference. This refers to the nucleation of small vapor bubbles during the pre-pulse phase, also known as early nucleation. When early nucleation occurs the vapor bubbles resulting from applying the main pulse can actually be smaller than without a pre-pulse. This is because when the main pulse is applied the vapor bubbles generated during the pre-pulse phase end up thermally isolating the ink from the heater. Even if the small early nucleation bubbles have collapsed by the time the main pulse is applied, the disturbance of the temperature gradient next to the heater surface of the heating element is large enough to cause a detrimental effect on the vapor bubble size.

Open pool experiments coupled with thermal simulations show that early nucleation typically occur at heater surface temperatures well below the nucleation temperature of the ink (˜300° C.). This is believed to be due to the presence of crevices and impurities on the heater surface that act as early nucleation sites where bubble growth tends to start.

Another constraint of more practical nature that needs to be taken into account in designing pulse trains is the fact that the pulse train is made out of digital bits or ticks of an electronic clock of a finite size. Typical ticks are of the order of 0.1 μs in duration.

As the purpose of the pre-pulses is to have an efficient jetting mechanism, it is advantageous to only put in the least amount of energy necessary to form the correct drop mass and the correct drop speed. As shown in FIG. 7, this is accomplished with initially long pre-pulses P1 and P2, followed by shorter pre-pulses P3, P4, P5, P6, and then one long pulse P7 at the end. This embodiment is more efficient than just having one main pulse of the length P7, and more efficient than having many pre-pulses of the constant length and then one main pulse, as shown in FIG. 3.

According to various exemplary embodiments, the present invention is utilized to maintain a constant drop volume, and, in addition, the present invention is utilized to control drop volume. Thus, smaller drops may be fired when smaller drops are desired, and larger drops may be created when larger drops are desired.

FIG. 8 graphically shows a drop velocity versus time that may be used to determine an optimum main firing pulse length. The horizontal axis is in microseconds, and the vertical axis is in meters per second. An operating voltage is chosen for the main pulse length. At this operating voltage, drop velocity is measured for a main pulse length of, for example, 1 microsecond. Then, the main pulse length is increased (from 1 to 1.1 microseconds, for example), the drop velocity is again measured. This process continues up to a maximum pulse length, for example, up to 4 microseconds. In this particular graph, from 1 to 1.1 microseconds, drop velocities increase. After 1.6 microseconds, drop velocities decrease. The curves starts to decrease when there is bubble interference on the fluid ejecting head, as all vapor bubbles on the heating element do not burst at the same time. The optimum drop velocity occurs at the fastest drop velocity, and this occurs at a main pulse length of 1.6 microseconds, thus 1.6 microseconds is the optimum main firing pulse length in this particular example.

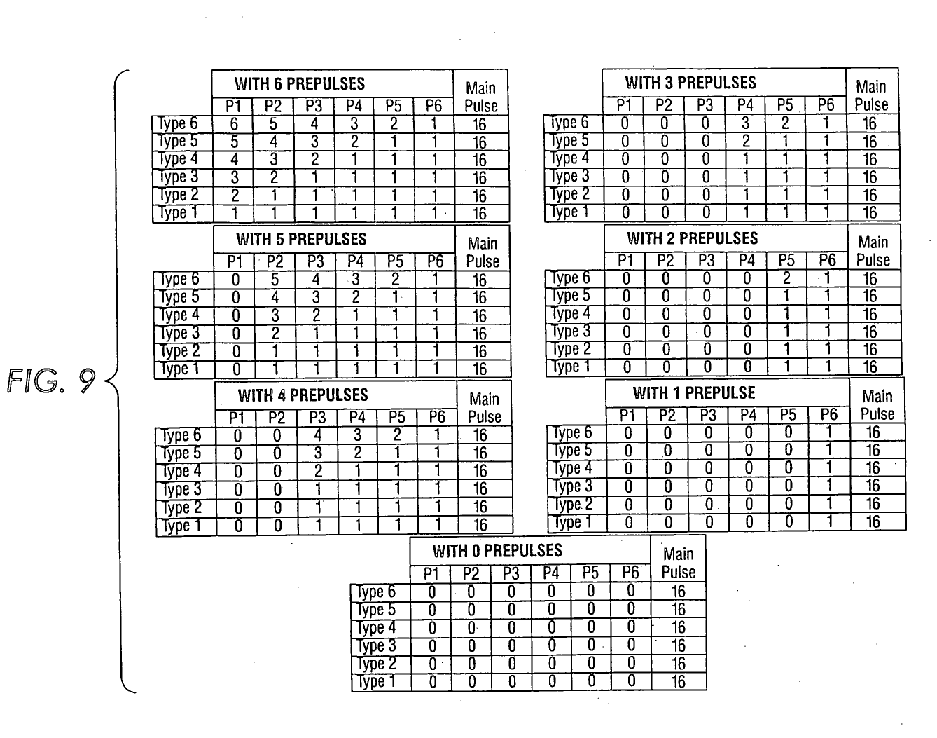

FIG. 9 is a listing of exemplary pre-pulse train embodiments used to determine the optimum waveform for a fluid ejecting head. Types 1 through 6 represent different mapped out pre-pulses, with pre-pulses P1 through P6, where P1 is the earliest pre-pulse and P6 is the last pre-pulse. The numbers under P1 through P6 represent the duration of a pre-pulse. The units shown for each pre-pulse duration are in 0.1 microseconds.

For example, for the type 1 pre-pulse train, there is only a single duration pre-pulse. For the type 2 pre-pulse train, for example, the first pre-pulse is twice as long as any other pre-pulse in the type 2 pulse train. For type 3, for example, the first pre-pulse P1 is 0.3 micro-seconds, the second pre-pulse P2 is 0.2 micro-seconds, and the remaining pre-pulses P3 through P6 are all 0.1 micro-second in length. For type 4 for example, the first pre-pulse P1 is 0.4 micro-seconds, the second pre-pulse P2 is 0.3 micro-seconds, the third pre-pulse P3 is 0.2 micro-seconds in length, and the remaining pre-pulses P4 through P6 are all 0.2 micro-second in length. For type 5 for example, the first pre-pulse P1 is 0.5 micro-seconds, the second pre-pulse P2 is 0.4 micro-seconds, the third pre-pulse P3 is 0.3 micro-seconds in length, the fourth pre-pulse is 0.2 microseconds in length, and the remaining pre-pulses P5 and P6 are both 0.1 micro-second in length. For type 6 for example, the first pre-pulse P1 is 0.6 micro-seconds, the second pre-pulse P2 is 0.5 micro-seconds, the third pre-pulse P3 is 0.4 micro-seconds in length, the fourth pre-pulse is 0.3 microseconds in length, the fifth pre-pulse is 0.2 micro-seconds in length, and the sixth pre-pulse is 0.1 micro-second in length.

FIG. 9 also shows a main pulse length, also in 0.1 unit microseconds. This main pulse length is the optimum main pulse length determined in FIG. 8.

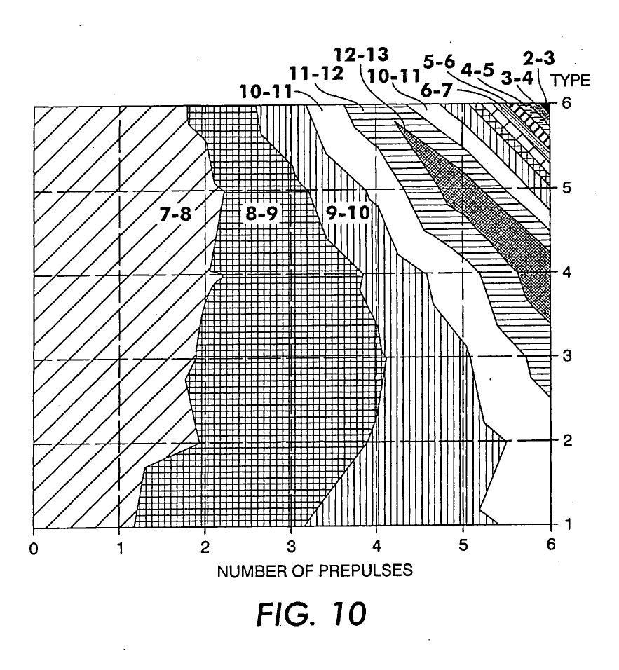

FIG. 10 is an exemplary embodiment of a contour plot of drop velocity generated from a number of pre-pulses (horizontal axis) and the types of pre-pulse (vertical axis) shown in FIG. 9. The far-left portion of the graph shows an area representing drop velocity of 7-8 meters per second (m/s). One step to the right of the far-left portion in the graph shows an area representing drop velocity of 8-9 m/s. Then, to the right of the 8-9 m/s area, the graph shows drop velocities of 9-10 m/s. Continuing to the right, the graph shows areas representing drop velocities of 10-11 m/s, 11-12 m/s, and 12-13 m/s, which is the highest velocity achieved. Continuing to the right from the 12-13 m/s area, then velocity in the graph decreases.

The optimum enable wave trains are generally optimum when used in conjunction with initially low temperature fluid ejecting heads, and are generally in the fastest section (shown as the lightest section in FIG. 10), i.e., the section of the graph where a drop velocity of 12-13 m/s exists. In this particular graph area/section, the optimum wave trains or waveforms are type 4, with 6 pre-pulses, and type 5, with 5 pre-pulses. Among these two optimum waveforms, the one with the greater number or pre-pulses (i.e., type 4 with 6 pre-pulses) advantageously provides the greatest range of control, because there are a greater number of pre-pulses. Therefore, pre-pulses are removed if the fluid ejecting head starts at a higher temperature and less heating is needed.

The determined optimum enable wave train is stored in a look-up table for retrieval by the fluid ejecting head circuitry.

While the invention has been described in relation to preferred embodiments, many modifications and variations are apparent from the description of the invention, and all such modifications and variations are intended to be within the scope of the present invention as defined in the appended claims.

1. A method of using a thermal fluid jet assembly having at least one fluid ejecting head, the at least one fluid ejecting head having a plurality of fluid ejectors, each of the plurality of fluid ejectors having a heating element which is activated in response to data signals to eject a fluid droplet from the at least one fluid ejecting head, the method comprising:
applying a plurality of variable duration pre-pulses to the at least one fluid ejecting head in response to data signals received; and
applying at least one pulse to the at least one fluid ejecting head that actuates selected fluid ejectors of the plurality of fluid ejectors.

2. The method of claim 1, wherein at least two of the plurality of pre-pulses to the fluid ejecting head are of different duration.

3. The method of claim 1, further comprising:
controlling a waveform of the plurality of pre-pulses to achieve a desired volume of the fluid droplet to be ejected from the at least one fluid ejecting head.

4. The method of claim 1, further comprising:
controlling a waveform of the plurality of pre-pulses to achieve a desired gray level on a receiving medium.

5. The method of claim 1, wherein the plurality of pre-pulses comprises a first set of pre-pulses that are longer in duration then a second, subsequent set of pre-pulses.

6. The method of claim 1, further comprising retrieving the plurality of variable duration pre-pulses from a look-up table.

7. The method of claim 1, wherein the plurality of variable duration pre-pulses to the fluid ejecting head heat the fluid ejecting head.

8. The method of claim 1, wherein the plurality of variable duration pre-pulses of the fluid ejecting head heat fluid contained within the fluid ejecting head.

9. The method of claim 8, wherein the fluid is ink or a medicament.

10. The method of claim 1, wherein the plurality of variable duration pre-pulses are determined based on at least one of a temperature of the fluid ejecting head, a type of fluid used, a type of print mode and a physical characteristic of the fluid ejector head.

11. The method of claim 10, wherein the one physical characteristic of the fluid ejector head comprises a type of fluid ejecting head, an area of the fluid ejecting head, a shape of the fluid ejecting head, or a layer structure of the fluid ejecting head.

12. The method of claim 1, wherein the fluid ejecting head is a printhead.

13. The method of claim 1, further comprising applying a plurality of print signals to the fluid ejecting head, the plurality of print signals corresponding to an image for the fluid jet assembly to create.

14. The method of claim 1, wherein the plurality of variable duration pre-pulses are a plurality of variable duration non-nucleating electrical pre-pulses.

15. The method of claim 1, wherein the at least one pulse is at least one nucleating electrical pulse.

16. A thermal fluid drop ejector, comprising:
a print data storage element configured to receive print data from a printer controller;
a pulse data delay element configured to receive pulse data, including at least two pre-pulses of different duration and at least one pulse, from either a fluid ejecting head controller or a previous drop ejector and sends the pulse data to a next drop ejector after a predetermined delay;
a heating element; and
a combinational element that, when the data storage element contains print data, and the pulse data delay element contains pulse data, activates the heating element according to the print data and the pulse data.

17. The thermal fluid drop ejector of claim 16, wherein the at least two pre-pulses are at least two non-nucleating electrical pre-pulses.

18. The thermal fluid drop ejector of claim 16, wherein the at least one pulse is at least one nucleating electrical pulse.

19. The thermal fluid drop ejector of claim 16, wherein the pulse data is stored by the pulse delay element prior to being applied to the heating element.

20. The thermal fluid drop ejector of claim 16, wherein the print data is stored by the print data storage element prior to applying the at least one pulse signal.

21. The thermal fluid drop ejector of claim 16, wherein the pulse data achieves a desired gray level on a receiving medium.

22. The thermal fluid drop ejector of claim 16, wherein the pulse data is stored in a look-up table.

23. The thermal fluid drop ejector of claim 16, wherein the at least two non-nucleating electrical pre-pulses of different duration are determined based on at least one of the temperature of the ejector, a type of ink used, a type of printing to be done and a physical characteristic of the ejector.

24. The thermal fluid drop ejector of claim 23, wherein the physical characteristics of the ejector comprises the type of ejector, the area of the ejector, the shape of the ejector, or the layer structure of the ejector.

25. The thermal fluid drop ejector of claim 16, wherein the at least two non-nucleating electrical pre-pulses heat the ejector.

26. The thermal fluid drop ejector of claim 16, wherein the at least two non-nucleating electrical pre-pulses heat fluid contained within the ejector.

27. The thermal fluid, drop ejector of claim 16, wherein the pulse data is based on a desired volume of a fluid droplet to be ejected from the ejector.

28. The thermal fluid drop ejector of claim 16, wherein the combinational elements simultaneously activate non adjacent heater elements.
